(19) United States
(12) Patent Application Publication
(10) Pub. No.: US 2018/0238338 A1
(43) Pub. Date: Aug. 23, 2018

(54) BLOWER APPARATUS

(71) Applicant: NIDEC CORPORATION, Kyoto (JP)

(72) Inventors: Takehito Tamaoka, Kyoto (JP); Masashi Hirayama, Kyoto (JP); Naruyuki Horaitani, Kyoto (JP); Shun Hirano, Kyoto (JP); Takayuki Ito, Kyoto (JP)

(73) Assignee: NIDEC CORPORATION, Kyoto (JP)

(21) Appl. No.: 15/900,129

(22) Filed: Feb. 20, 2018

Related U.S. Application Data
(60) Provisional application No. 62/460,333, filed on Feb. 17, 2017.

(30) Foreign Application Priority Data
May 15, 2017 (JP) 2017-096621

(51) Int. Cl. F04D 29/28; F04D 25/06; F04D 29/30; F04D 29/42; F04D 29/66

(52) U.S. Cl. CPC F04D 29/283; F04D 25/06; G06F 1/203; F04D 29/4226; F04D 29/666; F04D 29/30

(57) ABSTRACT

A blower apparatus includes an impeller arranged to be capable of rotating about a central axis extending in a vertical direction, and a motor arranged to drive the impeller. The impeller includes a plurality of blade portions arranged in a circumferential direction, and a flange portion arranged to have the blade portions arranged on an outer peripheral portion thereof on a radially outer side. At least one of the blade portions includes a shoulder portion at an end portion thereof on a radially inner side and on one axial side. The shoulder portion includes a first end surface arranged to face to the one axial side, a second end surface arranged to face to the one axial side and arranged on another axial side of the first end surface, and a third end surface arranged to join an inner end portion of the first end surface on the radially inner side and an outer end portion of the second end surface on the radially outer side to each other.

### BACKGROUND OF THE INVENTION

### 1. Field of the Invention

The present invention relates to a blower apparatus.

### 2. Description of the Related Art

A blower apparatus is known which is arranged to send air radially outward by using a motor to rotate a plurality of blade portions about an axis. Such a blower apparatus is arranged to send air which flows from, for example, an air inlet arranged on an axially upper side into a space between circumferentially adjacent ones of the blade portions radially outward through rotation of the blade portions to send the air to a space outside of the blower apparatus. Such a blower apparatus is used as, for example, a cooling fan in an electronic device which is required to have a reduced thickness.

Japanese Patent No. 5012096 teaches an electric blower including an impeller including a plurality of blades, which is a related-art blower related to the present invention. In this electric blower, a radially outermost end portion of each blade is arranged to have a multiple-step staircase-like shape to double the apparent number of blades, thus shifting annoying noise generated from the electric blower to higher frequencies to reduce the annoying noise.

### SUMMARY OF THE INVENTION

A reduction in the thickness of a blower apparatus leads to a reduction in the axial dimension of blade portions and a reduction in an area of each blade portion which is involved in driving away air, resulting in reduced air blowing efficiency of the blower apparatus. Increasing the number of blade portions will increase the total area of portions of the blade portions which are involved in driving away air. However, this will result in a reduced width of a space between radially inner end portions of circumferentially adjacent ones of the blade portions. This will make it difficult for air sucked into the blower apparatus to flow into the aforementioned space, resulting in reduced air blowing efficiency. In addition, when an impeller is rotating, the sucked air may separate from a surface of each blade portion to flow between adjacent ones of the blade portions and a housing or turn into an eddy, resulting in increased noise. The above problem is in no way mentioned in Japanese Patent No. 5012096.

A blower apparatus according to a preferred embodiment of the present invention includes an impeller arranged to be capable of rotating about a central axis extending in a vertical direction, and a motor arranged to drive the impeller. The impeller includes a plurality of blade portions arranged in a circumferential direction, and a flange portion arranged to have the plurality of blade portions arranged on an outer peripheral portion thereof on a radially outer side. At least one of the plurality of blade portions includes a shoulder portion at an end portion thereof on a radially inner side and on one axial side. The shoulder portion includes a first end surface arranged to face to the one axial side, a second end surface arranged to face to the one axial side and arranged on another axial side of the first end surface, and a third end surface arranged to join an inner end portion of the first end surface on the radially inner side and an outer end portion of the second end surface on the radially outer side to each other.

The blower apparatus according to the above preferred embodiment of the present invention is able to achieve reduced noise and improved air blowing efficiency.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a blower apparatus according to a preferred embodiment of the present invention.

FIG. 2 is a sectional view illustrating an exemplary structure of the blower apparatus.

FIG. 3 is a top view of an impeller according to a preferred embodiment of the present invention.

FIG. 4 is a sectional view of a portion of the blower apparatus as viewed in a circumferential direction.

FIG. 5 is a sectional view of one of blade portions according to a preferred embodiment of the present invention when viewed along the length of the blade portion.

FIG. 6A is a perspective view of the impeller.

FIG. 6B is a perspective view illustrating an example of the structures of the blade portions.

FIG. 6C is a top view illustrating inner end portions of some of the blade portions on a radially inner side in an enlarged form.

FIG. 7A is a perspective view illustrating the structures of blade portions according to a modification of the above preferred embodiment of the present invention.

FIG. 7B is a diagram illustrating an example section of one of the blade portions on the radially inner side of an outside surface of a flange portion according to a modification of the above preferred embodiment of the present invention.

FIG. 7C is a diagram illustrating an example section of one of the blade portions on the radially outer side of the outside surface of the flange portion according to a modification of the above preferred embodiment of the present invention.

FIG. 7D is a diagram illustrating an example section of one of the blade portions on the radially outer side of the outside surface of the flange portion according to another modification of the above preferred embodiment of the present invention.

FIG. 8 is a sectional view illustrating the structure of a blower apparatus according to a first modification of the above preferred embodiment of the present invention.

FIG. 9 is a sectional view illustrating the structure of a blower apparatus according to a second modification of the above preferred embodiment of the present invention.

FIG. 10A is a perspective view illustrating an example of a laptop information apparatus in which the blower apparatus according to the above preferred embodiment of the present invention is installed.

FIG. 10B is a perspective view illustrating an example structure of the blower apparatus according to the above preferred embodiment of the present invention with a heat pipe attached thereto.

### DETAILED DESCRIPTION OF THE PREFERRED EMBODIMENTS

Hereinafter, preferred embodiments of the present invention will be described with reference to the accompanying drawings.

It is assumed herein that a direction parallel to a central axis CA of a blower apparatus 100 is referred to by the term “axial direction”, “axial”, or “axially”. It is also assumed herein that a direction leading from a support plate portion 402, which will be described below, to an intake plate portion 401, which will be described below, in an axial direction is referred to as an upward direction. It is also assumed herein that a direction leading from the intake plate portion 401 to the support plate portion 402 in the axial direction is referred to as a downward direction. It is also assumed herein that an end portion of any structural element on an axially upper side is referred to as an “upper end portion”, while an end portion of any structural element on an axially lower side is referred to as a “lower end portion”. It is also assumed herein that an end surface of any structural element on the axially upper side is referred to as an “upper end surface” as one end surface lying on one axial side, while an end surface of any structural element on the axially lower side is referred to as a “lower end surface” as another end surface lying on another axial side.

It is also assumed herein that directions perpendicular to the central axis CA are each referred to by the term “radial direction”, “radial”, or “radially”. It is also assumed herein that a direction leading toward the central axis CA in a radial direction is referred to as a radially inward direction, while a direction leading away from the central axis CA in the radial direction is referred to as a radially outward direction. It is also assumed herein that a side surface of any structural element which lies radially inward is referred to as an “inside surface”, while a side surface of any structural element which lies radially outward is referred to as an “outside surface”. It is also assumed herein that an end portion of any structural element on a radially inner side is referred to as an “inner end portion”, while an end portion of any structural element on a radially outer side is referred to as an “outer end portion”. More specifically, when viewed in the axial direction, the “inner end portion” with respect to a radial direction overlaps with the “inside surface”, and the “outer end portion” with respect to the radial direction overlaps with the “outside surface”. It is also assumed herein that a portion of any structural element which lies radially inward of the “outer end portion” with respect to the radial direction and in the vicinity of the “outer end portion” with respect to the radial direction is referred to as an “outer peripheral portion”.

It is also assumed herein that a circumferential direction about the central axis CA is referred to by the term “circumferential direction”, “circumferential”, or “circumferentially”. It is also assumed herein that one side in a circumferential direction corresponds to a forward side with respect to a rotation direction Dro of an impeller 200 and blade portions 1, which will be described below, while another side in the circumferential direction corresponds to a rearward side with respect to the rotation direction Dro. It is also assumed herein that a side surface of any structural element which lies on the rearward side with respect to the rotation direction Dro in the circumferential direction is referred to as a “trailing edge surface”, while a side surface of any structural element which lies on the forward side with respect to the rotation direction Dro in the circumferential direction is referred to as a “leading edge surface”.

It should be noted that the above definitions of the directions, surfaces, portions, etc., are not meant to restrict in any way relative positions, directions, etc., of different members or portions of a blower apparatus according to any preferred embodiment of the present invention when actually installed in a device.

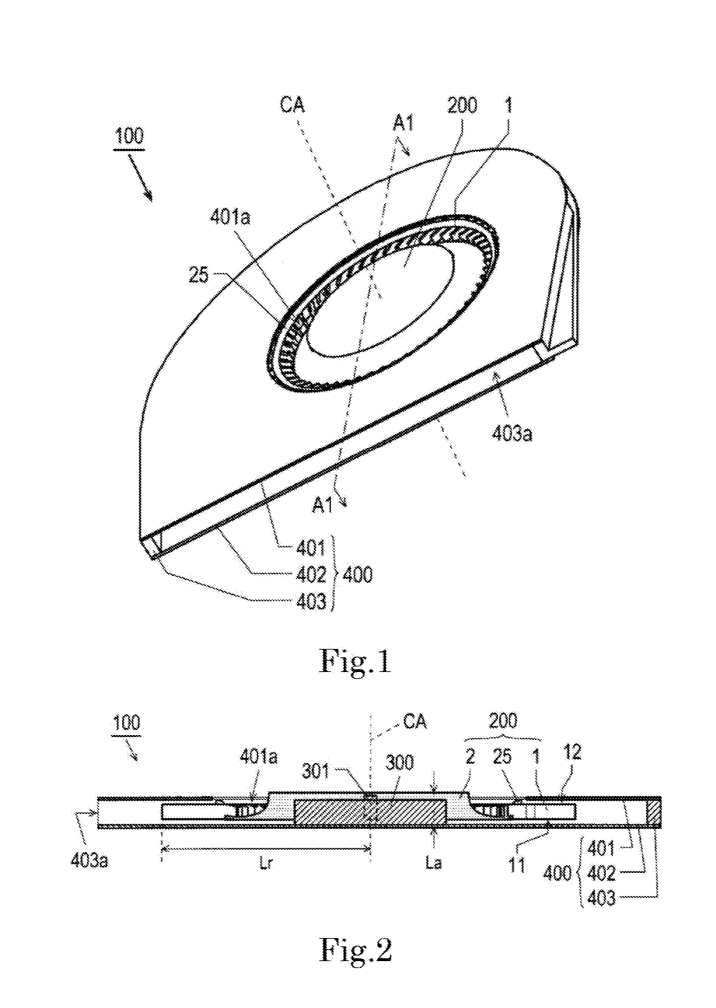

FIG. 1 is a perspective view of a blower apparatus 100 according to a preferred embodiment of the present invention. FIG. 2 is a sectional view illustrating an exemplary structure of the blower apparatus 100. FIG. 2 illustrates a section of the blower apparatus 100 taken along a plane including a central axis CA and along dot-dashed line A1-A1 in FIG. 1.

The blower apparatus 100 includes an impeller 200, a motor 300, and a housing 400.

The impeller 200 is an impeller including a plurality of blade portions 1, and is attached to the motor 300. The impeller 200 is arranged to be capable of rotating about the central axis CA, which extends in a vertical direction, together with a shaft 301 of the motor 300. The shortest radial distance Lr from the central axis CA to an outer end portion (i.e., a tip) of each blade portion 1 on the radially outer side is greater than an axial dimension La of the blower apparatus 100, and is preferably equal to or greater than five times the axial dimension La. This allows the blower apparatus 100 to have a slim shape. The structure of the impeller 200 will be described below.

The motor 300 is arranged to drive the impeller 200 by rotating the shaft 301 about the central axis CA.

The housing 400 is arranged to accommodate the impeller 200 and the motor 300. The housing 400 includes an intake plate portion 401, a support plate portion 402, and a side wall portion 403.

The intake plate portion 401 is arranged on the axially upper side of the blade portions 1, and opposite to a blade upper end surface 12, which is an end surface of each blade portion 1 on the axially upper side, with a gap therebetween. The intake plate portion 401 includes an air inlet 401a arranged to pass therethrough in the axial direction.

The support plate portion 402 is arranged on the axially lower side of the blade portions 1, and opposite to a blade lower end surface 11, which is an end surface of each blade portion 1 on the axially lower side, with a gap therebetween to support the motor 300. More specifically, the motor 300 is fixed to an upper surface of the support plate portion 402. The upper surface of the support plate portion 402 is arranged axially opposite to a lower surface of the intake plate portion 401.

The side wall portion 403 is arranged between the lower surface of the intake plate portion 401 and the upper surface of the support plate portion 402 to define an interior space to accommodate the impeller 200 and the motor 300 together with the intake plate portion 401 and the support plate portion 402. An air outlet 403a which faces in a radial direction is defined in the side wall portion 403. The interior space of the housing 400 accommodates the impeller 200 and the motor 300, and is in communication with a space outside of the housing 400 through the air inlet 401a and the air outlet 403a.

Each of the intake plate portion 401, the support plate portion 402, and the side wall portion 403 is made of, for example, a metal, but may alternatively be made of any other desirable material. For example, each of the intake plate portion 401 and the support plate portion 402 is made of stainless steel, and the side wall portion 403 is made of copper. In addition, the side wall portion 403 is defined by forging, casting, or press working, and is subjected to an insert molding process or an outsert molding process together with the intake plate portion 401 and the support plate portion 402. The molded housing 400 is subjected to a cutting process after the molding to ensure that the housing 400 is shaped with sufficient accuracy.

In addition, a wind caused by rotation of the impeller 200 directly strikes the side wall portion 403. Accordingly, the side wall portion 403 is preferably arranged to have a high thermal conductivity, preferably 100 W/m·K or higher, for example. In this case, even if air having a relatively high temperature flows into the blower apparatus 100, heat of this air, which is sent radially outward by the rotation of the impeller 200, can be effectively dissipated through the side wall portion 403. This effect is particularly beneficial when the blower apparatus 100 is used as an air cooling fan.

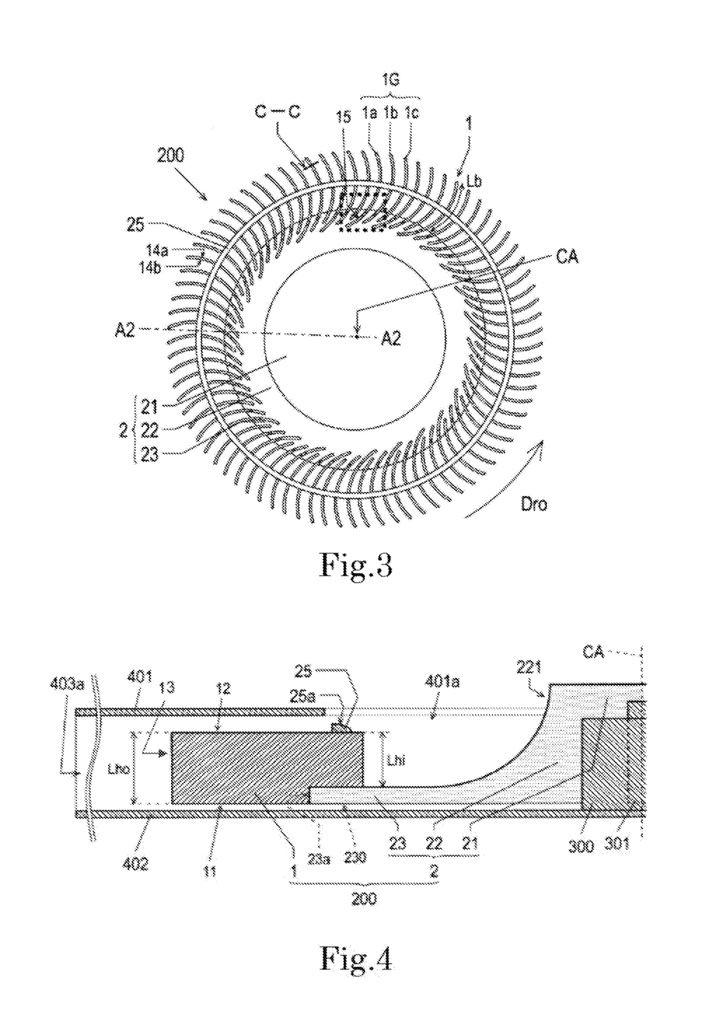

Next, the structure of the impeller 200 will now be described below. FIG. 3 is a top view of the impeller 200. FIG. 4 is a sectional view of a portion of the blower apparatus 100 as viewed in the circumferential direction. FIG. 4 corresponds to a section of a portion of the blower apparatus 100 taken along dot-dashed line A1-A1 in FIG. 1, and a section of a portion of the impeller 200 taken along dot-dashed line A2-A2 in FIG. 3.

The impeller 200 includes the plurality of blade portions 1, a cover portion 21, a tubular portion 22, a flange portion 23, and a ring portion 25. In addition, the cover portion 21, the tubular portion 22, and the flange portion 23 together define a cup portion 2. That is, the impeller 200 includes the cup portion 2. The cup portion 2 is arranged to accommodate an upper end portion of the motor 300 on the axially upper side. In other words, the cup portion 2 is attached to an upper end of the motor 300. The structure of each blade portion 1 will be described below.

The blade portions 1 are arranged in the circumferential direction. The number of blade portions 1 is preferably a prime number to reduce noise caused when the blade portions 1 drive away air. In addition, the number of blade portions 1 is preferably 31 or more, for example. As the number of blade portions 1 increases, a space between adjacent ones of the blade portions 1 decreases in width, and static pressure between the adjacent blade portions 1 accordingly increases, causing air between the adjacent blade portions 1 to be sent radially outward with greater force. This leads to improved air blowing efficiency of the blower apparatus 100. The structure of each blade portion 1 will be described below.

The cover portion 21 is joined to the shaft 301, and is arranged to cover an upper surface of the motor 300. The tubular portion 22 is arranged to extend at least axially downward from an outer end portion of the cover portion 21 on the radially outer side. The cover portion 21 and the tubular portion 22 together define an interior space to accommodate the upper end portion of the motor 300 on the axially upper side. In addition, an outside surface of the tubular portion 22 includes a curved surface 221. In a section as viewed in the circumferential direction, the curved surface 221 faces axially upward and radially outward, and, further, is concave to a side opposite to a direction in which the curved surface 221 faces. A center of curvature of the curved surface 221 lies on a side of the curved surface 221 which the curved surface 221 faces. Accordingly, air flowing radially outward along the curved surface 221 smoothly flows to reach the flange portion 23. The flange portion 23 is arranged to extend radially outward from an outer end portion of the tubular portion 22 on the radially outer side. The blade portions 1 are arranged on an outer peripheral portion 230 of the flange portion 23 on the radially outer side.

When the impeller 200 is rotating, air which flows into the interior space of the housing 400 through the air inlet 401a flows radially outward along the curved surface 221 and an upper surface of the flange portion 23 into a space between adjacent ones of the blade portions 1. This air is caused by the blade portions 1 rotating in the circumferential direction to flow radially outward away from the impeller 200 as a wind, and to be sent to the space outside of the housing 400 through the air outlet 403a.

The ring portion 25 is annular, and is arranged to join the blade portions 1 to each other on the axially upper side of the blade portions 1. Note that the present invention is not limited to this example, and that the ring portion 25 may alternatively be arranged to join the blade portions 1 to each other on the axially lower side of the blade portions 1. That is, the ring portion 25 is arranged on at least one of the axially upper and lower sides of the blade portions 1 to join the blade portions 1 to each other on the at least one of the axially upper and lower sides of the blade portions 1. The joining of the blade portions 1 by the annular ring portion 25 improves strength of each of the blade portions 1 arranged in the impeller 200. When the annular ring portion 25 is arranged on the axially upper side of the blade portions 1, the annular ring portion 25 contributes to reducing or preventing a backflow of air once sucked in through the air inlet 401a toward the air inlet 401a. Here, another air inlet (not shown) may be defined in, for example, the support plate portion 402. In this case, if the annular ring portion 25 is arranged on the axially lower side of the blade portions 1, the annular ring portion 25 arranged on the axially lower side of the blade portions 1 contributes to reducing or preventing a backflow of air once sucked in through the other air inlet toward the other air inlet.

The ring portion 25 includes a curved surface 25a. In a section as viewed in the circumferential direction, the curved surface 25a has such a curved shape as to be convex axially upward and radially inward. This allows air sucked in through the air inlet 401a to flow along the curved surface 25a of the ring portion 25. This makes a separation of a flow of the air from the curved surface 25a less likely to happen, resulting in improved air intake efficiency.

Next, the structure of each blade portion 1 will now be described below. Referring to FIGS. 3 and 4, each blade portion 1 is arranged to extend at least radially outward from the outer peripheral portion 230 of the flange portion 23. This arrangement allows a greater number of blade portions 1 to be arranged in the circumferential direction than, for example, in the case where the blade portions 1 are arranged to extend from an inner peripheral portion of the flange portion 23.

An inner end portion of each blade portion 1 on the radially inner side is arranged to overlap with the air inlet 401a when viewed in the axial direction. Thus, the blade portion 1 is able to generate a wind by driving away air sucked in through the air inlet 401a. In addition, an area of the blade portion 1 which is involved in driving away air becomes larger than in the case where the inner end portion of the blade portion 1 on the radially inner side lies radially outward of the air inlet 401a, and the blade portion 1 is therefore able to generate a greater volume of wind. This results in an improvement in efficiency with which air is sucked in through the air inlet 401a, resulting in an additional increase in a flow rate of the blower apparatus 100.

In addition, the inner end portion of the blade portion 1 on the radially inner side is arranged to project axially upward from the flange portion 23 at the outer peripheral portion 230 of the flange portion 23. Because, when viewed in the axial direction, the inner end portion of the blade portion 1 is arranged to project at the outer peripheral portion 230, a greater number of blade portions 1 can be arranged in the circumferential direction than, for example, in the case where the inner end portion of the blade portion 1 is arranged at a central portion of the impeller 200. Thus, an increase in the flow rate of the blower apparatus 100 can be easily achieved.

Referring to FIG. 3, each blade portion 1 is arranged to curve in the circumferential direction when viewed in the axial direction. More specifically, each blade portion 1 is arranged to have such a curved shape as to be convex rearward with respect to the rotation direction Dro in the circumferential direction. Referring to FIGS. 3 and 4, a distance Lb, along the blade portion 1, from an outside surface 23a of the flange portion 23 on the radially outer side to the outer end portion of the blade portion 1 on the radially outer side when viewed in the axial direction is longer than an axial dimension Lho of the blade portion 1 on the radially outer side of the outside surface 23a. This leads to an additional reduction in the axial dimension of each blade portion 1 of the impeller 200, and accordingly contributes to a reduction in the size of the blower apparatus 100.

In addition, the axial dimension Lho of the blade portion 1 on the radially outer side of the outside surface 23a is greater than an axial dimension Lhi of the blade portion 1 on the radially inner side of the outside surface 23a. This leads to an additional increase in the area of the blade portion 1 which is involved in driving away air, and accordingly allows the blade portion 1 to generate a greater volume of wind. This in turn results in an increase in the flow rate of the blower apparatus 100.

Each blade portion 1 is made of a resin. Although, in the present preferred embodiment, all the blade portions 1 are portions of a member including the flange portion 23, the present invention is not limited to this example. Some or all of the blade portions 1 may alternatively be defined by a member made of a resin and separate from the flange portion 23. That is, only one or more of the blade portions 1 may be made of a resin and be a portion(s) of the member including the flange portion 23. Alternatively, all the blade portions 1 may be defined by members separate from the flange portion 23. Note, however, that it is preferable that at least one of the blade portions 1 is made of a resin and a portion of the member including the flange portion 23. This will lead to a reduction in the number of processes for manufacturing the blower apparatus 100 when compared to the case where all the blade portions 1 are defined by members separate from the flange portion 23, and accordingly achieve a reduction in a time required to manufacture the blower apparatus 100 (e.g., a takt time), achieving improved manufacturing efficiency.

Referring to FIG. 4, each blade portion 1 includes the blade lower end surface 11, which is opposite to the support plate portion 402, the blade upper end surface 12, which is opposite to the intake plate portion 401, and a blade outside surface 13. In addition, referring to FIG. 3, each blade portion 1 further includes a trailing edge surface 14a arranged on the rearward side of the blade portion 1 with respect to the rotation direction Dro of the impeller 200 in the circumferential direction, and a leading edge surface 14b arranged on the forward side of the blade portion 1 with respect to the rotation direction Dro of the impeller 200 in the circumferential direction. When the impeller 200 is rotating, the leading edge surface 14b of each blade portion 1 presses air, resulting in an application of a positive pressure to the leading edge surface 14b and an application of a negative pressure to the trailing edge surface 14a.

In addition, each of the trailing edge surface 14a and the leading edge surface 14b of each blade portion 1 is arranged to curve in the circumferential direction when viewed in the axial direction. More specifically, when viewed in the axial direction, each of the trailing edge surface 14a and the leading edge surface 14b of each blade portion 1 is arranged to have such a curved shape as to be convex rearward with respect to the rotation direction Dro in the circumferential direction. This allows air which is sent radially outward between circumferentially adjacent ones of the blade portions 1 when the impeller 200 is rotating to flow along the trailing edge surface 14a of one of the adjacent blade portions 1, which curves in the circumferential direction. This reduces the likelihood of an occurrence of an eddy on the trailing edge surface 14a, and, further, leads to reduced noise.

In addition, at least one of the blade portions 1 includes a shoulder portion 15, which will be described below, at an end portion thereof on the radially inner side and on the axially upper side. The structure of the blade portion 1 including the shoulder portion 15 and the structure of the shoulder portion 15 will be described below.

Next, the structure of the trailing edge surface 14a of each blade portion 1 will now be described below. FIG. 5 is a sectional view of one of the blade portions 1 as viewed along the length of the blade portion 1. FIG. 5 illustrates a section of the blade portion 1 taken along, for example, line C-C in FIG. 3, which is perpendicular to the length of the blade portion 1 and the axial direction.

The trailing edge surface 14a of each blade portion 1 includes a rear surface 141, a first curved surface 142, and a second curved surface 143. In a plan view as viewed in the axial direction, each of the rear surface 141, the first curved surface 142, and the second curved surface 143 is arranged to have such a curved shape as to be convex rearward with respect to the rotation direction Dro in the circumferential direction.

The rear surface 141 is arranged to extend straight in parallel with the axial direction in a section as viewed along the length of the blade portion 1.

In a section as viewed along the length of the blade portion 1, the first curved surface 142 is arranged to have such a curved shape as to be convex axially upward and rearward with respect to the rotation direction Dro in the circumferential direction, and is joined to the upper end surface 12 of the blade portion 1 and an upper end portion of the rear surface 141 on the axially upper side. More specifically, in the section as viewed along the length of the blade portion 1, the first curved surface 142 is arranged to have such a curved shape as to be convex axially upward and rearward with respect to the rotation direction Dro in the circumferential direction. An upper end portion of the first curved surface 142 on the axially upper side is joined to an end portion of the blade upper end surface 12 on the rearward side with respect to the rotation direction Dro in the circumferential direction. In addition, a lower end portion of the first curved surface 142 on the axially lower side is joined to the upper end portion of the rear surface 141 on the axially upper side.

In addition, it is preferable that the first curved surface 142 is smoothly joined to the blade upper end surface 12 and the rear surface 141. More specifically, in a section of the blade portion 1 as viewed along the length of the blade portion 1, a tangent to the first curved surface 142 at an axially upper end thereof is preferably parallel to a tangent to the blade upper end surface 12 at an end thereof on the rearward side with respect to the rotation direction Dro in the circumferential direction. In addition, in the section of the blade portion 1 as viewed along the length of the blade portion 1, a tangent to the first curved surface 142 at an axially lower end thereof is preferably parallel to the rear surface 141. This reduces or eliminates the likelihood of an abrupt change in a direction in which air flows from above the blade upper end surface 12 onto the first curved surface 142, and also reduces or eliminates the likelihood of an abrupt change in a direction in which air flows from above the first curved surface 142 onto the rear surface 141. This in turn contributes to reducing noise owing to provision of the first curved surface 142 in the trailing edge surface 14a.

In a section as viewed along the length of the blade portion 1, the second curved surface 143 is arranged to have such a curved shape as to be convex axially downward and rearward with respect to the rotation direction Dro in the circumferential direction, and is joined to the lower end surface 11 of the blade portion 1 and a lower end portion of the rear surface 141 on the axially lower side. More specifically, in the section as viewed along the length of the blade portion 1, the second curved surface 143 is arranged to have such a curved shape as to be convex axially downward and rearward with respect to the rotation direction Dro in the circumferential direction. A lower end portion of the second curved surface 143 on the axially lower side is joined to an end portion of the blade lower end surface 11 on the rearward side with respect to the rotation direction Dro in the circumferential direction. In addition, an upper end portion of the second curved surface 143 on the axially upper side is joined to the lower end portion of the rear surface 141 on the axially lower side.

In addition, it is preferable that the second curved surface 143 is smoothly joined to the blade lower end surface 11 and the rear surface 141. More specifically, in the section of the blade portion 1 as viewed along the length of the blade portion 1, a tangent to the second curved surface 143 at an axially upper end thereof is preferably parallel to the rear surface 141. In addition, in the section of the blade portion 1 as viewed along the length of the blade portion 1, a tangent to the second curved surface 143 at an axially lower end thereof is preferably parallel to a tangent to the blade lower end surface 11 at an end thereof on the rearward side with respect to the rotation direction Dro in the circumferential direction. This reduces or eliminates the likelihood of an abrupt change in a direction in which air flows from below the blade lower end surface 11 onto the second curved surface 143, and also reduces or eliminates the likelihood of an abrupt change in a direction in which air flows from below the second curved surface 143 onto the rear surface 141. This in turn contributes to reducing noise owing to provision of the second curved surface 143 in the trailing edge surface 14a.

In FIG. 5, in the section of the blade portion 1 as viewed along the length of the blade portion 1, an axial width (Wa1+Wa2+Wa3) of the blade portion 1 is, for example, 1.4 mm. An axial width Wa1 of the rear surface 141 is, for example, 0.8 mm. An axial width Wa2 of the first curved surface 142 is, for example, 0.3 mm. An axial width Wa3 of the second curved surface 143 is, for example, 0.3 mm.

In addition, in the section of the blade portion 1 as viewed along the length of the blade portion 1, a thickness We of the blade portion 1 measured in a direction perpendicular to both the length of the blade portion 1 and the axial direction is constant, and is, for example, in the range of 0.25 mm to 0.8 mm. In the present preferred embodiment, the thickness We of the blade portion 1 is 0.5 mm. A sufficient strength of the blade portion 1 can be ensured by arranging the blade portion 1 to have an appropriate thickness.

Although, in the present preferred embodiment, the trailing edge surface 14a includes both the first and second curved surfaces 142 and 143, the present invention is not limited to this example. For example, the trailing edge surface 14a may alternatively be arranged to include neither of the first and second curved surfaces 142 and 143, or may alternatively be arranged to include only one of the first and second curved surfaces 142 and 143.

However, in view of reducing noise, it is preferable that the trailing edge surface 14a includes at least one of the first and second curved surfaces 142 and 143. This will reduce the likelihood that an eddy will be generated in the vicinity of the trailing edge surface 14a of the blade portion 1 on the rearward side thereof with respect to the rotation direction Dro of the impeller 200 in the circumferential direction when the impeller 200 is rotating while the blower apparatus 100 is running. This in turn will contribute to reducing noise caused by the rotation of the impeller 200.

In addition, an analysis result obtained by a computer simulation, for example, shows that a noise reduction effect produced by the first curved surface 142 is stronger than a noise reduction effect produced by the second curved surface 143. Accordingly, a configuration in which only the first curved surface 142 is included in the trailing edge surface 14a is preferable to a configuration in which only the second curved surface 143 is included in the trailing edge surface 14a. Further, a configuration in which both the first and second curved surfaces 142 and 143 are included in the trailing edge surface 14a is more desirable in that an additional reduction in noise caused by the rotation of the impeller 200 can be achieved. The strength of the noise reduction effect decreases in the following order: “the configuration in which both the first and second curved surfaces 142 and 143 are included in the trailing edge surface 14a”>“the configuration in which only the first curved surface 142 is included in the trailing edge surface 14a”>“the configuration in which only the second curved surface 143 is included in the trailing edge surface 14a”>“a configuration in which neither of the first and second curved surfaces 142 and 143 is included in the trailing edge surface 14a”.

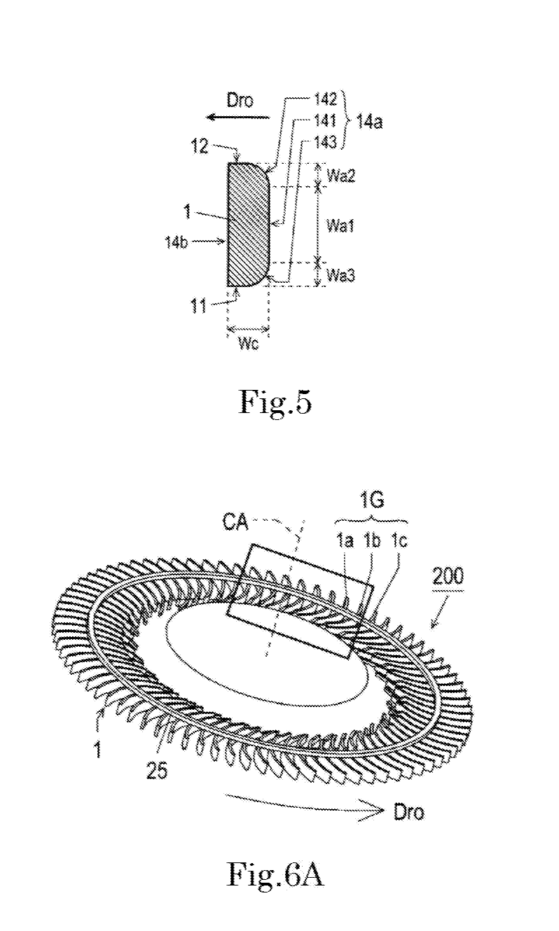

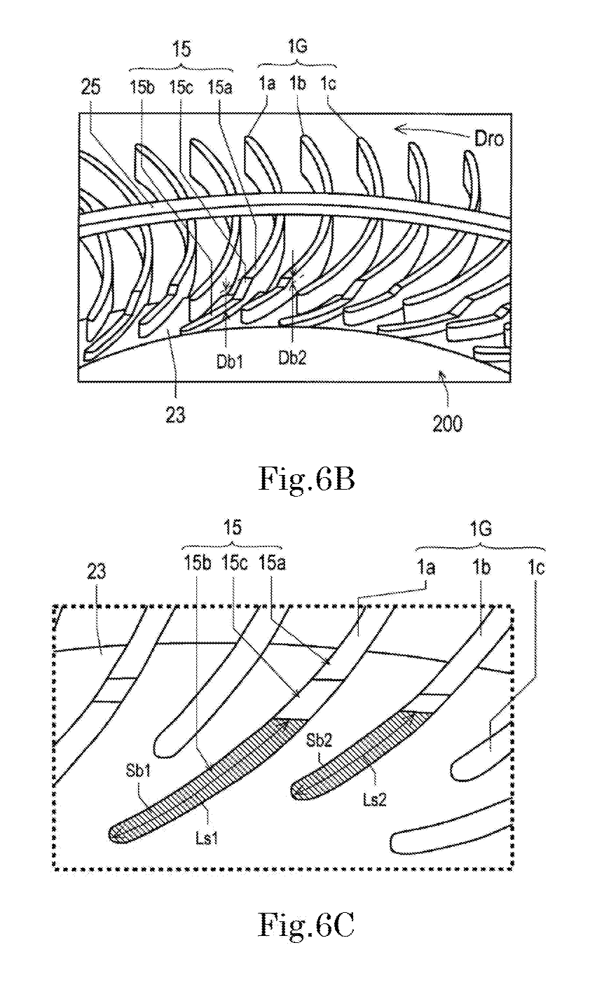

Next, the structures of the blade portions 1 arranged on the outer peripheral portion 230 of the flange portion 23 will now be described below. FIGS. 6A, 6B, and 6C are diagrams for explaining the structures of the blade portions 1. FIG. 6A is a perspective view of the impeller 200. FIG. 6B is a perspective view illustrating an example of the structures of the blade portions 1. FIG. 6C is a top view illustrating the inner end portions of some of the blade portions 1 on the radially inner side in an enlarged form. FIG. 6B corresponds to, for example, an area enclosed by a solid line in FIG. 6A. FIG. 6C corresponds to, for example, an area enclosed by a broken line in FIG. 3.

The blade portions 1 include blade portion groups 1G. More specifically, the blade portions 1 include a plurality of blade portion groups 1G arranged in the circumferential direction.

Each blade portion group 1G includes a first blade portion 1a, a second blade portion 1b, and a third blade portion 1c. Each of the first and second blade portions 1a and 1b includes the shoulder portion 15 at an end portion thereof on the radially inner side and on the axially upper side. The third blade portion 1c does not include the shoulder portion 15. Note that, although each blade portion group 1G includes the first, second, and third blade portions 1a, 1b, and 1c in the present preferred embodiment, this is not essential to the present invention. Each blade portion group 1G may alternatively include only two of the first, second, and third blade portions 1a, 1b, and 1c. Also note that each blade portion group 1G may include a blade portion 1 other than the first to third blade portions 1a to 1c.

In each blade portion group 1G, the second blade portion 1b is arranged circumferentially adjacent to the first blade portion 1a, and the third blade portion 1c is arranged circumferentially adjacent to the second blade portion 1b. In addition, the first blade portion 1a is arranged on the forward side of the second blade portion 1b with respect to the rotation direction Dro of the blade portion group 1G. In addition, the third blade portion 1c is arranged on the rearward side of the second blade portion 1b with respect to the rotation direction Dro in the circumferential direction.

An inner end portion of the second blade portion 1b on the radially inner side is arranged radially outward of an inner end portion of the first blade portion 1a on the radially inner side. In addition, an inner end portion of the third blade portion 1c on the radially inner side is arranged radially outward of both the inner end portion of the first blade portion 1a on the radially inner side and the inner end portion of the second blade portion 1b on the radially inner side.

Because each of the first and second blade portions 1a and 1b includes the shoulder portion 15, the inner end portion of each of the first and second blade portions 1a and 1b on the radially inner side has an axial dimension smaller than that of the inner end portion of the third blade portion 1c on the radially inner side. In addition, the inner end portion of the first blade portion 1a on the radially inner side is arranged to have an axial dimension smaller than that of the inner end portion of the second blade portion 1b on the radially inner side. The above arrangement makes it easier for a portion of air that flows above the shoulder portion 15 of the first blade portion 1a to flow into a space between the first and second blade portions 1a and 1b, and for air that flows above the shoulder portion 15 of the second blade portion 1b to flow into a space between the second and third blade portions 1b and 1c.

Next, the structure of the shoulder portion 15 will now be described below with reference to FIGS. 6A to 6C. In the inner end portion of at least one of the blade portions 1 on the radially inner side, the shoulder portion 15 is arranged on the axially upper side. At least one of the blade portions 1 including the shoulder portion 15 on the radially inner side and on the axially upper side as described above contributes to preventing air from separating from a surface of any blade portion 1 when the impeller 200 is rotating, and reducing the likelihood of an occurrence of an eddy and of noise. In addition, it is made easier for air to flow into the space between adjacent ones of the blade portions 1. Thus, the blower apparatus 100 is able to achieve improved air blowing efficiency.

Referring to FIG. 6B, each shoulder portion 15 is arranged on the radially inner side of the annular ring portion 25 arranged on the axially upper side of the blade portions 1. Flows of air on the radially outer side of the annular ring portion 25 tend to have a relatively large effect on the air blowing efficiency of the blower apparatus 100. Therefore, an additional improvement in the air blowing efficiency of the blower apparatus 100 can be achieved by arranging the shoulder portion 15 on the radially inner side of the annular ring portion 25 to smoothen the flow of air, and allowing the air, flowing smoothly, to be sent radially outward.

Each shoulder portion 15 includes a first end surface 15a, a second end surface 15b, and a third end surface 15c. In the present preferred embodiment, each of the first, second, and third end surfaces 15a, 15b, and 15c is a portion of the blade upper end surface 12, and is arranged to extend from an end portion of the blade portion 1 on the forward side with respect to the rotation direction Dro to an end portion of the blade portion 1 on the rearward side with respect to the rotation direction Dro in the circumferential direction.

The first end surface 15a is arranged to face axially upward, and is arranged on the radially outer side of the third end surface 15c.

The second end surface 15b is arranged to face axially upward, and is arranged on the radially inner side of the third end surface 15c. In addition, the second end surface 15b is arranged on the radially inner side of the outside surface 23a of the flange portion 23 on the radially outer side when viewed in the axial direction, and is arranged on the axially lower side of the first end surface 15a.

The third end surface 15c is arranged to join an inner end portion of the first end surface 15a on the radially inner side and an outer end portion of the second end surface 15b on the radially outer side to each other. That is, an outer end portion of the third end surface 15c on the radially outer side is joined to the inner end portion of the first end surface 15a on the radially inner side. In addition, an inner end portion of the third end surface 15c on the radially inner side is joined to the outer end portion of the second end surface 15b on the radially outer side.

As described above, the shoulder portion 15 is included in each of the first and second blade portions 1a and 1b of each blade portion group 1G. Referring to FIG. 6B, an axial distance Db1 between the first and second end surfaces 15a and 15b of the shoulder portion 15 of the first blade portion 1a is arranged to be greater than an axial distance Db2 between the first and second end surfaces 15a and 15b of the shoulder portion 15 of the second blade portion 1b. In addition, the third end surface 15c in the first blade portion 1a is arranged radially inward of the third end surface 15c in the second blade portion 1b.

Referring to FIG. 6C, when viewed in the axial direction, a length Ls1 of the second end surface 15b in the first blade portion 1a is arranged to be greater than a length Ls2 of the second end surface 15b in the second blade portion 1b. The length Ls1 is a dimension of the second end surface 15b in the first blade portion 1a measured along the length of the first blade portion 1a when viewed in the axial direction. The length Ls2 is a dimension of the second end surface 15b in the second blade portion 1b measured along the length of the second blade portion 1b when viewed in the axial direction. The first end surface 15a in the first blade portion 1a and the first end surface 15a in the second blade portion 1b are arranged at the same axial position.

In addition, referring to FIG. 6C, when viewed in the axial direction, an area Sb2 of the second end surface 15b in the second blade portion 1b is arranged to be smaller than an area Sb1 of the second end surface 15b in the first blade portion 1a.

The above arrangements make it easier for air that flows above the second end surface 15b in the first blade portion 1a to flow into the space between the first and second blade portions 1a and 1b. Thus, an increase in the volume of air driven away by the second blade portion 1b is achieved.

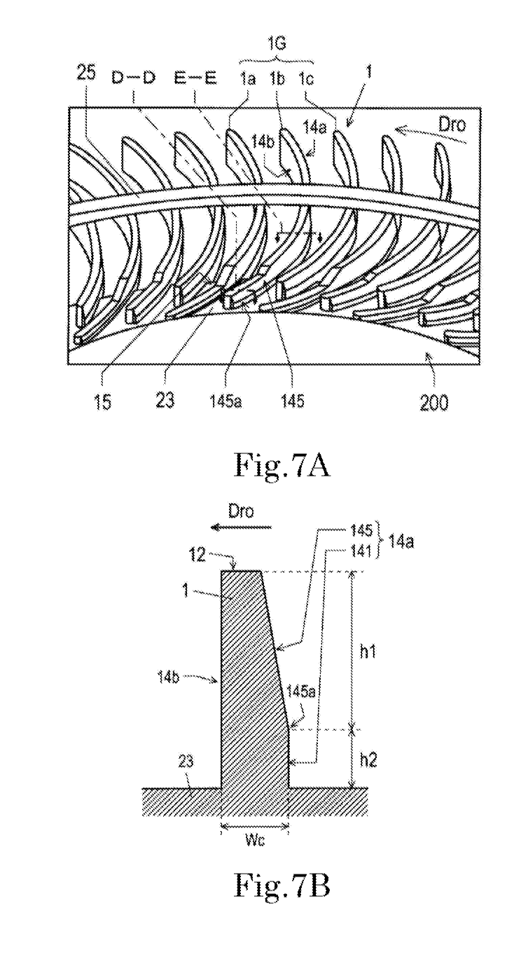

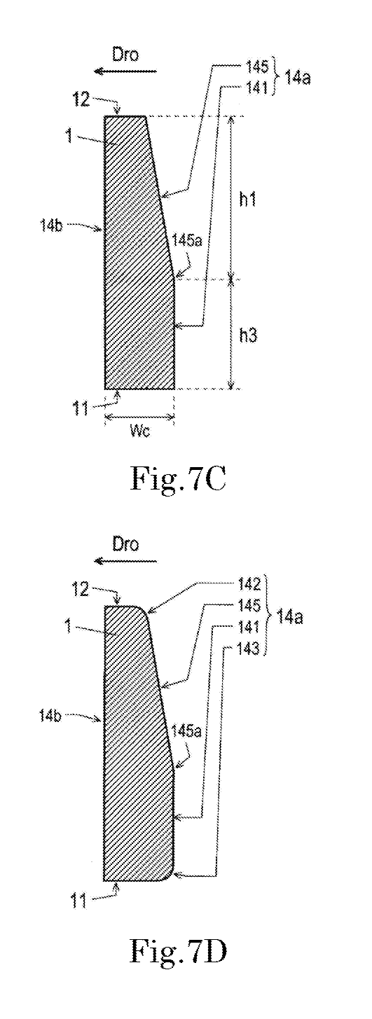

Next, the structures of blade portions 1 according to a modification of the present preferred embodiment will now be described below. FIG. 7A is a perspective view illustrating the structures of the blade portions 1 according to a modification of the present preferred embodiment. FIG. 7B is a sectional view illustrating an example section of one of the blade portions 1 on the radially inner side of an outside surface 23a of a flange portion 23. FIG. 7C is a sectional view illustrating an example section of one of the blade portions 1 on the radially outer side of the outside surface 23a of the flange portion 23. FIG. 7A corresponds to, for example, the area enclosed by the solid line in FIG. 6A. FIG. 7B corresponds to a section of the blade portion 1 taken along dot-dashed line D-D in FIG. 7A. FIG. 7C corresponds to a section of the blade portion 1 taken along dot-dashed line E-E in FIG. 7A.

Each blade portion 1 further includes a slanting surface 145 in an inner end portion thereof on the radially inner side, the slanting surface 145 being included in a trailing edge surface 14a of the blade portion 1 arranged on the rearward side of the blade portion 1 with respect to the rotation direction Dro in the circumferential direction. In other words, the trailing edge surface 14a of each blade portion 1 includes a rear surface 141 and the slanting surface 145. Note that the present invention is not limited to this example, and that only some and not all of the blade portions 1 may include the slanting surface 145. That is, it may be sufficient if at least one of the blade portions 1 includes the slanting surface 145 in the inner end portion thereof on the radially inner side, the slanting surface 145 being included in the trailing edge surface 14a.

The slanting surface 145 is arranged to extend from an upper end portion of the blade portion 1 on the axially upper side rearward with respect to the rotation direction Dro in the circumferential direction, and to the axially lower side at an angle with respect to a plane PL perpendicular to a central axis CA. Referring to FIGS. 7B and 7C, the slanting surface 145 is joined to both a blade upper end surface 12 and the rear surface 141. That is, an upper end portion of the slanting surface 145 on the axially upper side is joined to an end portion of the blade upper end surface 12 on the rearward side with respect to the rotation direction Dro in the circumferential direction, and a lower end portion (i.e., an edge portion 145a) of the slanting surface 145 on the axially lower side is joined to an upper end portion of the rear surface 141 on the axially upper side.

Referring to FIG. 7B, when viewed in the circumferential direction, an axial distance h1 between the upper end portion of the blade portion 1 on the axially upper side and the edge portion 145a of the slanting surface 145 on the axially lower side is arranged to be greater than an axial distance h2 between the edge portion 145a and an upper surface of the flange portion 23. In addition, referring to FIG. 7C, when viewed in the circumferential direction, the aforementioned axial distance h1 is arranged to be greater than an axial distance h3 between the edge portion 145a and a lower end portion of the blade portion 1 on the axially lower side. Notice that the aforementioned axial distance h3 is greater than the aforementioned axial distance h2.

With the above arrangements, the slanting surface 145, which has a relatively large area, of each blade portion 1 allows air that flows in the circumferential direction above the end portion of the blade portion 1 on the axially upper side to smoothly flow into a space on the rearward side of the blade portion 1 with respect to the rotation direction Dro in the circumferential direction. Thus, the flow of air into the space between adjacent ones of the blade portions 1 is further facilitated, resulting in an additional improvement in air blowing efficiency of a blower apparatus 100.

In a modification of the present preferred embodiment as illustrated in FIGS. 7A to 7C, each blade portion 1 includes neither of the first and second curved surfaces 142 and 143 (see FIG. 5). Note, however, that the present invention is not limited to this example, and that each blade portion 1 may further include at least one of the first and second curved surfaces 142 and 143. That is, in a modification of the present preferred embodiment, the trailing edge surface 14a may further include the first curved surface 142, or may further include the second curved surface 143. Alternatively, in a modification of the present preferred embodiment, the trailing edge surface 14a may further include both the first and second curved surfaces 142 and 143 as illustrated in FIG. 7D, which corresponds to, for example, a section of one of the blade portions 1 taken along dot-dashed line E-E in FIG. 7A. In the case where the trailing edge surface 14a according to a modification of the present preferred embodiment includes at least the first curved surface 142, the slanting surface 145 is arranged to extend from a lower end portion of the first curved surface 142 on the axially lower side. Provision of at least one of the first and second curved surfaces 142 and 143 in the trailing edge surface 14a contributes to reducing noise caused by the rotation of the impeller 200.

In a section as viewed in the circumferential direction, each of the blade upper end surface 12 of each blade portion 1 and a portion of the intake plate portion 401 which is opposite to the blade upper end surface 12 is arranged to extend straight in the radial direction in the present preferred embodiment. Note, however, that the present invention is not limited to this example.

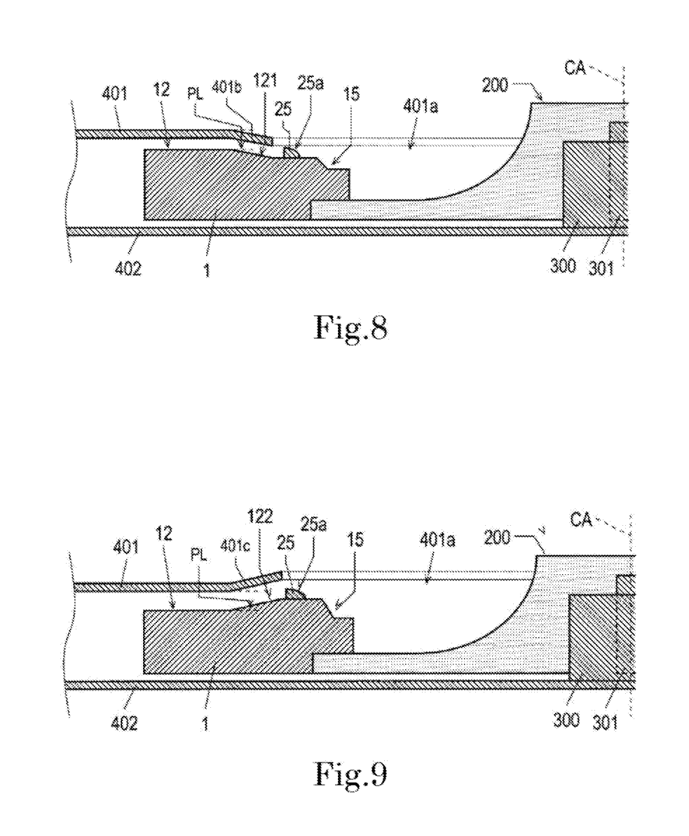

FIG. 8 is a sectional view illustrating the structure of a blower apparatus 100 according to a first modification of the above-described preferred embodiment, which will now be described below. Referring to FIG. 8, each of blade portions 1 further includes a first blade end surface 121 arranged on the radially outer side of a ring portion 25. That is, a blade upper end surface 12 includes the first blade end surface 121. When viewed in the circumferential direction, the first blade end surface 121 is angled axially upward with respect to a plane PL perpendicular to a central axis CA with increasing distance from the central axis CA. An intake plate portion 401 further includes a first plate portion 401b. The first plate portion 401b is arranged to be parallel to the first blade end surface 121 of the blade portion 1 on the axially upper side of the first blade end surface 121. This results in a relatively small width of a gap between the ring portion 25 and the first plate portion 401b, which contributes to preventing a backflow of air at the gap.

FIG. 9 is a sectional view illustrating the structure of a blower apparatus 100 according to a second modification of the above-described preferred embodiment, which will now be described below. Referring to FIG. 9, each of blade portions 1 further includes a second blade end surface 122 arranged on the radially outer side of a ring portion 25. That is, a blade upper end surface 12 includes the second blade end surface 122. When viewed in the circumferential direction, the second blade end surface 122 is angled axially downward with respect to a plane PL perpendicular to a central axis CA with increasing distance from the central axis CA. An intake plate portion 401 further includes a second plate portion 401c. The second plate portion 401c is arranged to be parallel to the second blade end surface 122 of the blade portion 1 on the axially upper side of the second blade end surface 122. This contributes to increasing the efficiency with which air is sucked in through an air inlet 401a, leading to an easy increase in a flow rate of the blower apparatus 100.

Note that not only the first and second modifications illustrated in FIGS. 8 and 9, respectively, are possible, but the first and second modifications may be combined appropriately. For example, in another modification of the above-described preferred embodiment, an intake plate portion 401 may include a second plate portion 401c and a first plate portion 401b arranged to extend radially inward from an inner end portion of the second plate portion 401c on the radially inner side, and, in addition, a blade upper end surface 12 may include a second blade end surface 122 and a first blade end surface 121 arranged to extend radially inward from an inner end portion of the second blade end surface 122 on the radially inner side. This will contribute to preventing a backflow of air at a gap between a blade portion 1 and the intake plate portion 401, and additionally contribute to preventing a backflow of air toward an air inlet 401a.

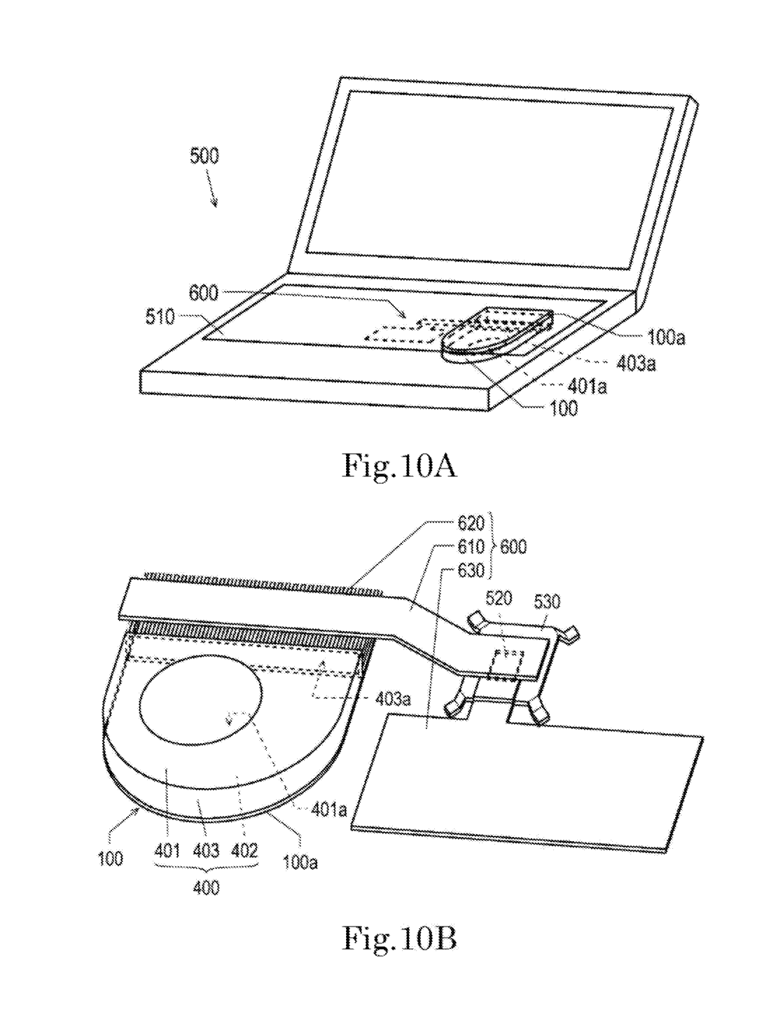

Next, an example application of the blower apparatus 100 will now be described below. FIG. 10A is a perspective view illustrating an example of a laptop information apparatus 500 in which the blower apparatus 100 is installed. FIG. 10B is a perspective view illustrating an example structure of the blower apparatus 100 with a heat pipe 600 attached thereto. Note that, in FIG. 10A, the upper and lower sides in the axial direction are reversed compared to those in FIGS. 1 to 9. More specifically, the upward direction in FIG. 10A corresponds to the axially downward direction in FIGS. 1 to 9, while the downward direction in FIG. 10A corresponds to the axially upward direction in FIGS. 1 to 9. In FIG. 10B, the upper and lower sides in the axial direction are the same as those in FIGS. 1 to 9.

The information apparatus 500 is, for example, a slim personal computer, such as a notebook personal computer. The blower apparatus 100 is used as an air cooling fan of the information apparatus 500, and is installed inside of the information apparatus 500 together with a sheet-shaped damper 100a and the heat pipe 600. The blower apparatus 100 and the heat pipe 600 are attached to, for example, a rear surface of a keyboard 510 of the information apparatus 500.

The damper 100a is a buffer member to protect the blower apparatus 100 from a shock, and is arranged on an axially lower surface of the blower apparatus 100. The blower apparatus 100 is attached to the rear surface of the keyboard 510 with the damper 100a therebetween.

The heat pipe 600 is a member to transfer heat generated from a heat-generating portion and an interior of the information apparatus 500. In FIG. 10B, the heat pipe 600 is arranged to transfer heat generated from the blower apparatus 100 and a CPU 520 installed in the information apparatus 500. The heat pipe 600 includes a heat transfer sheet 610, a heat sink 620, and a heat spreader 630.

The heat transfer sheet 610 is a strip-shaped heat transfer member, and is arranged to transfer heat from the CPU 520, which is arranged on a seat 530, to the heat sink 620. One end of the heat transfer sheet 610 is attached to the heat sink 620 such that heat can be transferred therebetween, while another end of the heat transfer sheet 610 is attached to the CPU 520 with the heat spreader 630 therebetween such that heat can be transferred therebetween.

The heat sink 620 is arranged at the air outlet 403a of the blower apparatus 100 so as to allow the blowing of air, and is arranged to transmit the heat transferred from the heat transfer sheet 610 to air sent from the air outlet 403a to achieve heat dissipation.

The heat spreader 630 is a sheet-shaped heat transfer member. A portion of the heat spreader 630 is attached to the CPU 520 such that heat can be transferred therebetween. In addition, another portion of the heat spreader 630 is attached to, for example, the rear surface of the keyboard 510 such that heat can be transferred therebetween. The heat spreader 630 is arranged to transfer heat of the CPU 520 to, for example, a casing (not shown) of the information apparatus 500 and air blown by the blower apparatus 100.

At least one of the intake plate portion 401, the support plate portion 402, and the side wall portion 403 of the blower apparatus 100 may be connected to the heat pipe 600 through, for example, a solder or a double-sided or single-sided adhesive tape having thermal conductivity such that heat can be transferred therebetween. For example, at least one of the intake plate portion 401, the support plate portion 402, and the side wall portion 403 may be connected to one end of the heat transfer sheet 610 through soldering or adhesion using the aforementioned tape such that heat can be transferred therebetween. Alternatively, one end of the heat transfer sheet 610 itself may be adhered to at least one of the intake plate portion 401, the support plate portion 402, and the side wall portion 403 of the blower apparatus 100 such that heat can be transferred therebetween. This allows the heat pipe 600 to efficiently transfer the heat to the housing 400 of the blower apparatus 100. Thus, the blower apparatus 100 is able to efficiently dissipate the heat generated in the CPU 520 to the air blown by the blower apparatus 100, and thus release the heat to a space outside of the information apparatus 500.

Preferred embodiments of the present invention have been described above. Note that the scope of the present invention is not limited to the above-described preferred embodiments. Various modifications may be made to the above-described preferred embodiments without departing from the gist of the present invention. Also note that features of the above-described preferred embodiments may be combined appropriately as long as no conflict arises.

Preferred embodiments of the present invention are applicable to, for example, slim blower fans. Note that applications of the present invention are not limited to this example.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A blower apparatus comprising:
an impeller arranged to be capable of rotating about a central axis extending in a vertical direction; and
a motor arranged to drive the impeller; wherein
the impeller includes:
a plurality of blade portions arranged in a circumferential direction; and
a flange portion arranged to have the plurality of blade portions arranged on an outer peripheral portion thereof on a radially outer side;
at least one of the plurality of blade portions includes a shoulder portion at an end portion thereof on a radially inner side and on one axial side; and
the shoulder portion includes a first end surface arranged to face to the one axial side, a second end surface arranged to face to the one axial side and arranged on another axial side of the first end surface, and a third end surface arranged to join an inner end portion of the first end surface on the radially inner side and an outer end portion of the second end surface on the radially outer side to each other.

2. The blower apparatus according to claim 1, wherein the second end surface is arranged on the radially inner side of an outside surface of the flange portion on the radially outer side when viewed in an axial direction.

3. The blower apparatus according to claim 1, wherein the second end surface is arranged to extend from an end portion of the blade portion on a forward side with respect to a rotation direction of the impeller to an end portion of the blade portion on a rearward side with respect to the rotation direction in the circumferential direction.

4. The blower apparatus according to claim 1, wherein the plurality of blade portions include at least one blade portion group including a first blade portion and a second blade portion arranged circumferentially adjacent to the first blade portion;
each of the first and second blade portions includes the shoulder portion;
the first blade portion is arranged on a forward side of the second blade portion with respect to a rotation direction of the at least one blade portion group; and
an area of the second end surface in the second blade portion is smaller than an area of the second end surface in the first blade portion.

5. The blower apparatus according to claim 4, wherein an axial distance between the first and second end surfaces of the shoulder portion of the first blade portion is greater than an axial distance between the first and second end surfaces of the shoulder portion of the second blade portion.

6. The blower apparatus according to claim 4, wherein, when viewed in the axial direction, a dimension of the second end surface in the first blade portion measured along a length of the first blade portion is greater than a dimension of the second end surface in the second blade portion measured along a length of the second blade portion.

7. The blower apparatus according to claim 4, wherein the third end surface in the first blade portion is arranged radially inward of the third end surface in the second blade portion.

8. The blower apparatus according to claim 4, wherein
the at least one blade portion group further includes a third blade portion arranged circumferentially adjacent to the second blade portion;
the third blade portion is arranged on a rearward side of the second blade portion with respect to the rotation direction of the at least one blade portion group in the circumferential direction; and
an end portion of the third blade portion on the radially inner side is arranged radially outward of both an end portion of the first blade portion on the radially inner side and an end portion of the second blade portion on the radially inner side.

9. The blower apparatus according to claim 4, wherein the at least one blade portion group includes a plurality of blade portion groups arranged in the circumferential direction.

10. The blower apparatus according to claim 4, wherein
each blade portion group includes the first blade portion, the second blade portion, and a third blade portion; and
the plurality of blade portions are 31 or more in number.

11. The blower apparatus according to claim 1, wherein
at least one of the plurality of blade portions includes a trailing edge surface arranged on a rearward side thereof with respect to a rotation direction of the impeller in the circumferential direction, and further includes a slanting surface in an end portion thereof on the radially inner side, the slanting surface being included in the trailing edge surface;
the slanting surface is arranged to extend from an end portion of the at least one blade portion on the one axial side rearward with respect to the rotation direction in the circumferential direction, and to the other axial side at an angle with respect to a plane perpendicular to the central axis; and
when viewed in the circumferential direction, an axial distance between the end portion of the at least one blade portion on the one axial side and an edge portion of the slanting surface on the other axial side is greater than an axial distance between the edge portion of the slanting surface on the other axial side and an end portion of the at least one blade portion on the other axial side.

12. The blower apparatus according to claim 1, wherein the impeller further includes an annular ring portion arranged to join the plurality of blade portions to each other on at least one of the one axial side and the other axial side of the plurality of blade portions.

13. The blower apparatus according to claim 12, wherein
the annular ring portion is arranged on the one axial side of the plurality of blade portions; and
the shoulder portion is arranged on the radially inner side of the ring portion.

14. The blower apparatus according to claim 1, further comprising a housing arranged to accommodate the impeller and the motor, wherein
the housing includes:
a first housing portion arranged opposite to an end surface of each blade portion on the one axial side with a gap therebetween; and
a second housing portion arranged opposite to an end surface of each blade portion on the other axial side with a gap therebetween; and
the first housing portion includes an air inlet arranged to pass therethrough in an axial direction.

15. The blower apparatus according to claim 14, wherein
each blade portion further includes a first blade end surface arranged on the radially outer side of the ring portion;
the first blade end surface is angled to the one axial side with respect to a plane perpendicular to the central axis with increasing distance from the central axis; and
the first housing portion further includes a first plate portion arranged to be parallel to the first blade end surface of the blade portion on the one axial side of the first blade end surface.

16. The blower apparatus according to claim 14, wherein
each blade portion further includes a second blade end surface arranged on the radially outer side of the ring portion;
the second blade end surface is angled to the other axial side with respect to a plane perpendicular to the central axis with increasing distance from the central axis; and
the first housing portion further includes a second plate portion arranged to be parallel to the second blade end surface of the blade portion on the one axial side of the second blade end surface.

17. The blower apparatus according to claim 14, wherein
the ring portion includes a curved surface; and
in a section as viewed in the circumferential direction, the curved surface is arranged to have such a curved shape as to be convex toward the one axial side and radially inward.
